(19) United States
(12) Patent Application Publication
(10) Pub. No.: US 2025/0194476 A1
(43) Pub. Date: Jun. 19, 2025

(54) SELF-WATERING SYSTEM AND METHOD FOR GROWING PLANTS

(71) Applicant: Atlas Tanguay, San Francisco, CA (US)

(72) Inventor: Atlas Tanguay, San Francisco, CA (US)

(21) Appl. No.: 18/542,614

(22) Filed: Dec. 16, 2023

(51) Int. Cl. A01G 25/06

(52) U.S. Cl. CPC A01G 25/06

(57) ABSTRACT

A self-watering system that's modular in nature and particularly suited for use in watering indoor, potted plants, includes a reservoir fillable with water and has an upper portion, and a lower portion. The system includes an upper lid and a lower lid that engage with the upper portion, and the lower portion of the reservoir respectively creating vacuum in the reservoir. The system further includes a base unit coupled to the lower lid and centered in the middle of the lower portion, and a water transfer member coupled to the base unit and in fluid communication with the reservoir. The water transfer member is adapted for delivering water into the soil of the potted plant.

### TECHNICAL FIELD

The present invention relates to a self-watering system for plants, and more particularly, the present invention relates to a modular self-watering system for potted plants and associated methods of watering plants.

### BACKGROUND

Gardening is a very popular job that a lot of users usually do. In urban environments and indoors, gardening is often limited to growing potted plants. Unfortunately, there are several problems associated with growing or watering these potted plants.

The most significant problem related to potted plants is watering these potted plants timely. Generally, a user taking care of plants has to determine when and how much water to provide to the plants to keep them lively. Plants of different types may require different amounts of water at different intervals. Again, the same or different types of plants located in sunny versus shaded areas or located in different types or sizes of pots may all have different levels of water needs. Thus, users need to carefully look into these plants to gauge their water needs. When it comes to the users who often forget to water their plants or who often go on vacation, they either have to employ some gardeners or let the plants die.

Self-watering systems such as watering globes, ceramic water spikes, and automatic drip watering systems available in the marketplace are increasingly becoming popular among users as a solution to watering plants without hiring any gardeners when they go on vacations or business trips or forget to water plants. The automatic drip watering systems commonly utilize pipes to deliver water from a source to a sprinkler head or the like, from which the water is dispensed to soil in pots or plants. A timer is configured to turn valves on and off, thus controlling the flow of water through the pipes. This type of system, however, is not well suited to use in supplying water to indoor plants. First, the normal irrigation system is configured to deliver water to several points using a common delivery pipe. For example, multiple sprinkler heads for watering a large area are supplied with water using a single delivery pipe. This configuration does not work with indoor plants or within a house environment, where each plant needs to be provided a unique amount of water at unique watering schedules.

The watering globes are another solution for plant watering. The orb of a globe is filled about ¾ with water. The globe is then inserted into the soil, and the water slowly seeps from the long thin neck of the globe into the plant's soil, providing constant soil moisture over time. As the water trickles out, a weak vacuum is formed within the globe, stopping too much water from escaping at once. As the soil moisture depletes, air can enter the globe once again and cause more water to be released. This keeps a steady supply of water entering the soil over time. It has been observed that water globes have little fill holes on the top, one should cautiously fill the orb. Also, it has been observed in the past, that the vacuum is not consistently maintained in the globes since these globes make use of rudimentary stoppers.

Another solution that has been particularly proposed for the potted plants is to provide potted plants with a bowl that can be filled with water. Water is drawn or “wicked” by the soil up from the bowl to the potted plant. Unfortunately, this solution does not address individual plant watering requirements.

Ceramic plant watering spikes are another solution to water potted plants. Several porous, ceramic spikes with attached hose are available in the market such as HydroSpike® Original HS-300 spikes. The ceramic spikes use capillary action for drawing water when the soil dries out, watering just when the plant needs it. The spikes seep water out at a consistent rate, but some of the spikes open to the air and lose water via evaporation, thus emptying the water source quicker than anticipation. The spikes need a water container containing the water connected therewith.

Various other solutions exist in the prior art for self-watering plants or potted plants. For instance, U.S. Pat. No. 5,352,253 discloses a process for watering a plant in a flowerpot, which is located on a foot inside a container of water. The footer ensures the pot is above water level, while absorbent wicks ensure that lead water from the container to the plant. Wick's one end is attached to the foot while the other end is manually forced through special openings on the side of the pot using a suitable rod when the pot is placed on the foot. The process requires a cumbersome manual operation.

U.S. Pat. No. 6,370,819 discloses self-watering pot plants. The flowerpot is supported by the mating surfaces at several evenly spaced pins or skewers, made of a material capable of transporting water from the water container. The legs extend from the bottom of a water container through a corresponding number of openings made in the pot bottom, into the soil in the pot to provide even watering when the water container contains water. This patent also describes the use of a single water-wicking leg. The water-wicking legs have a water-wicking base on which the flowerpot base is resting directly. This embodiment allows the container to contain only a limited amount of water because the pot will otherwise be in direct contact with irrigation water. The potted plant described in this patent can easily be over-watered resulting in constantly flooded roots of the plants that will rot the plant and the plant may die.

U.S. Pat. No. 4,117,632 discloses another self-watering system for potted plants, which comprises a liquid container, wherein an insert is provided with a wick for transporting liquid from the liquid container to the soil in the pot. The lower part of the insert is adapted to the liquid container and the wick extends along the upper part of the insert and is then guided into the insert about halfway down. As described in the patent, the wick is wound around the upper part of the insert creating a long transport path from the liquid in the liquid container to the potted plant. Further, it may be difficult to draw the wick into the insert.

The prior art solutions related to modular self-watering systems for potted plants are uneconomical, impractical to use in many cases, require human intervention and manual work, and are complex in nature. There is a need for an effective and efficient solution that solves the aforementioned problems of existing prior art solutions by providing a novel and modular self-watering system and method of operation.

### SUMMARY

While the way that the present disclosure addresses the disadvantages of the prior art will be discussed in greater detail below, in general, the present disclosure provides a modular self-watering system for potted plants and a method of operation.

An object of this invention is to provide a self-watering system that's simple in terms of design and easy to use and manufacture.

Another object of this invention is to provide a self-watering system that's modular in nature. The modularity of the components helps users to use a single self-watering system and use it for a multitude of potted plants that require different volumes of water at different schedules. For example, if a plant requires a higher volume of water, one can simply swap the water reservoir of the watering system with a differently sized water reservoir instead of completely replacing the watering system.

Another object of the present invention is to provide a self-watering system that uses a supporting stand (E.g. tripod stand) to provide stability to the watering system.

Another object of the present invention is to provide a self-watering system that allows a user to fill water into the reservoir without having to dislocate the watering system completely from the soil. One can simply open the upper lid and fill in water within the reservoir.

Embodiment of the present invention discloses a self-watering system for a potted plant. The watering system includes a reservoir having a body portion, an upper portion, and a lower portion, wherein the reservoir is fillable with water. The reservoir is hollow cylindrical in shape. The reservoir is replaceable with a reservoir having a different volume but having an identical upper portion and lower portion such as to allow use of an upper lid and the lower lid.

According to the embodiment, the self-watering system includes an upper lid that engages with the upper portion of the reservoir and a lower lid that engages with the lower portion of the reservoir. The diameter of the lower portion and the upper portion of the reservoir is reduced in comparison to the diameter of the body portion thereof. The diameter of the lower portion and the upper portion of the reservoir are identical to the diameter of the body portion thereof. The diameter of the lower portion and the upper portion of the reservoir are similar or different.

The upper lid is screwed on top of the upper portion of the reservoir utilizing a first O-ring located at an insert within the upper lid to create a vacuum seal. The lower lid is screwed at the bottom of the bottom portion of the reservoir such that a second set of internal threading of the lower lid engages with a second set of external threading located on the lower portion.

The upper lid is adapted to maintain a vacuum in the reservoir and allow for the pouring of water into the reservoir while the self-watering system is grounded on the potted plant.

According to the embodiment, the self-watering system includes a base unit coupled to the lower lid and centered in the middle of the lower portion. The water transfer member is a hollow straw of a predetermined length. The water transfer member is pointed at an end for ease of piercing into the soil to deliver the water inside. The base unit is screwed to the lower lid and the water transfer member is screwed to the base unit.

According to the embodiment, the self-watering system includes a water transfer member coupled to the base unit and in fluid communication with the reservoir, wherein the water transfer member is adapted for delivering water into the soil of the potted plant.

In an embodiment, the watering system further comprising a ring assembly having a plurality of legs connected thereto. The ring assembly with the plurality of legs acts as a stand to support and provide stability to the self-watering system.

In an embodiment, the watering system comprising an upper lid having a hose with a first end of the hose connected thereto for auto-filling the reservoir and a second end of the hose located within a vessel containing water.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures, and

FIG. 1 illustrates a self-watering system of the present invention, according to an embodiment of the present invention.

FIG. 2 illustrates a top view of the self-watering system of FIG. 1.

FIG. 3 illustrates a bottom view of the self-watering system of FIG. 1.

FIG. 4 illustrates an exploded view of the self-watering system of FIG. 1.

FIG. 5 shows a side view of a lid of the self-watering system of FIG. 1.

FIG. 6 shows a cross-sectional view of the lid of FIG. 5.

FIG. 7 shows a bottom view of the lid of the self-watering system of FIG. 1.

FIGS. 8 and 9 show a top perspective view and a side view of the reservoir of the self-watering system of FIG. 1.

FIG. 10 illustrates a self-watering system of the present invention, according to another embodiment of the present invention.

FIG. 11 illustrates a self-watering system of the present invention, according to yet another embodiment of the present invention.

FIGS. 12 and 13 illustrate a use case scenario of the self-watering system of FIGS. 1 and 11 respectively.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

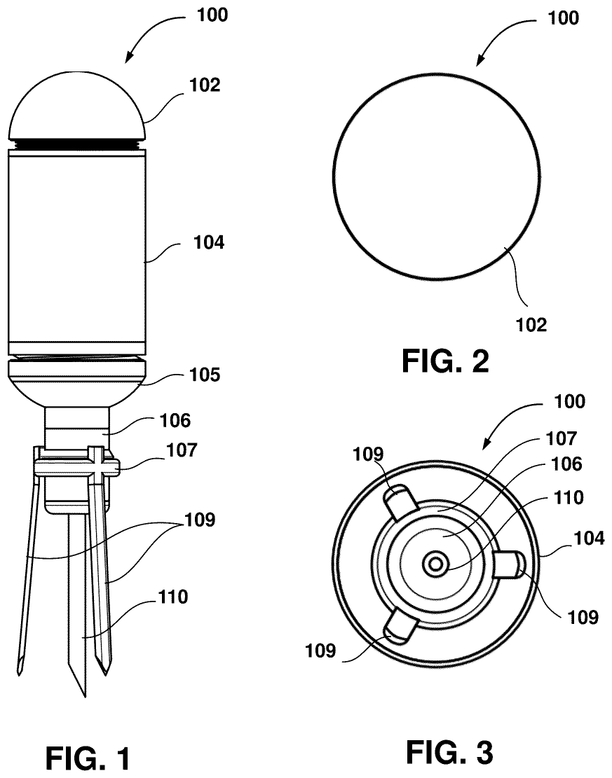

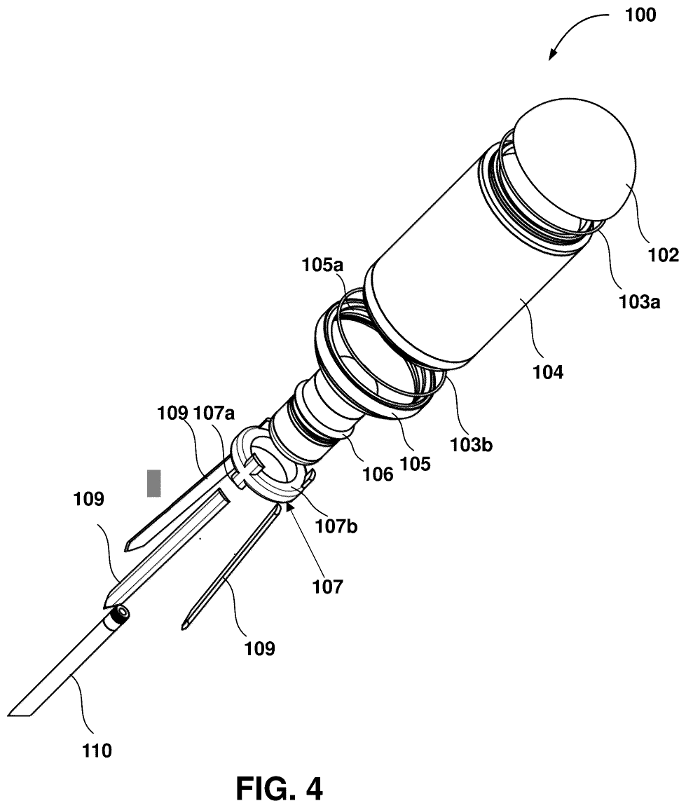

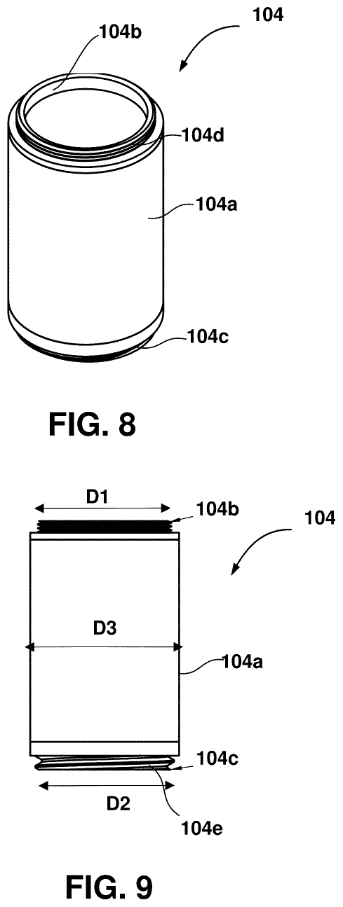

The self-watering system will now be described considering the accompanying drawings, particularly FIGS. 1-13.

Reference is initially made to FIGS. 1-4 that illustrates various views of a self-watering system 100, according to an embodiment of the present invention. The inventor views this particular embodiment as a preferred embodiment, however, there are possibilities that the preferred embodiment may be modified to arrive at several alternative embodiments. Attempts to explain the same will be carried out in the description to follow.

Referring to FIGS. 1-4, the self-watering system 100 is presented in the form of a modular system where different components forming the self-watering system 100 are easily removable, replaceable, and can be easily assembled or disassembled. The modular self-watering system 100 includes a reservoir 104. The reservoir 104 includes a body portion 104a, an upper portion 104b, and a lower portion 104c. The reservoir 104 is fillable with water or any other fluid essential for the growth of the plants or potted plants in general. The upper portion 104b and lower portion 104c are extensions extending from the body 104a. The reservoir 104 may be made as a single unitary product or the upper portion 104b and lower portion 104c may be fixedly attached at two ends of the body portion 104a.

In an embodiment, referring to FIG. 9, the diameter D2 of the lower portion 104c and the diameter D1 of the upper portion 104b of the reservoir 104 is reduced (smaller) in comparison to the diameter D3 of the body portion 104 of the reservoir 104. In other words, D3>D2 and D3>D1. In an embodiment, the diameter D2 of the lower portion 104c and diameter D1 of the upper portion 104b of the reservoir 104 are identical to the diameter D3 of the body portion 104. In other words, D2=D3 and D1=D3. In an embodiment, the diameter D2 of the lower portion 104c and diameter D1 of the upper portion 104 of the reservoir 104 are similar (D1=D2) or different D1<D2 or D1>D2. In an embodiment, the reservoir 104 is hollow cylindrical in shape, however, in principle the reservoir 104 may be angular, such as polygon, etc.

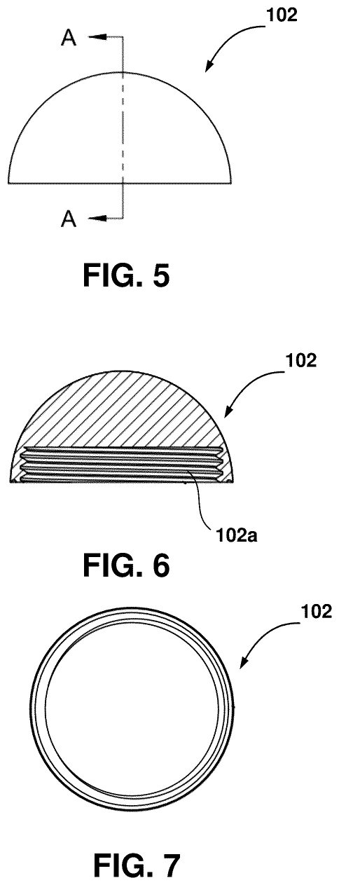

Referring to FIGS. 1-4 in conjunction with FIGS. 5-7, the self-watering system 100 further includes an upper lid 102 and a lower lid 105. The upper lid 102 engages with the upper portion 104b of the reservoir 104. In an embodiment, the upper lid 102 may be screwed on top of the upper portion 104b of the reservoir 104 such that a set of internal threading 102a of the upper lid 102 engages with a set of external threading 104d located on the upper portion 104b. An O-ring 103a is located at an insert within the upper lid 102. The upper lid 102 is screwed on top of the upper portion 104b utilizing the O-ring 103a for creating a vacuum seal in the reservoir 104. The upper lid 102 is shaped to complement the shape of the upper portion 104b. In the example, the body portion 104a, and upper portion 104b are shaped cylindrically so to complement the shape of the upper portion 104b, the upper lid 102 is shaped hemispherically with a set of threads 102a internally configured therein that engaged with the threads 104d. In an embodiment, where the reservoir 104 is shaped in an angular manner (Eg. polygonal, cuboidal, etc.) then accordingly the upper lid 102 will be shaped for the working of the upper lid 102. In the embodiment, the upper lid 102 is removably coupled on the upper portion 104b. The upper lid 102 is adapted to maintain a sealed vacuum in the reservoir 104 and allow the pouring of water into the reservoir 104. Maintaining a vacuum inside reservoir 104 helps in a steady flow of water from the reservoir 104 to the soil in the pot. To ensure proper vacuum creation in the reservoir 104, the O-ring 103a is utilized and placed in an insert located in proximity to the threads 102a of the upper lid 102. The opening of the upper lid 102 allows the filling up of the reservoir 104 without having to dislocate the self-watering system 100 from the soil of the potted plant. In another embodiment, the self-watering system 100 may be configured without utilizing the O-ring 103a.

Referring to FIGS. 1-4, the lower lid 105 engages with the lower portion 104c of the reservoir 104. The lower lid 105 is screwed at the bottom of the bottom portion 104c of the reservoir 104 such that a set of internal threading 105a of the lower lid 105 engages with a set of external threading 104e located on the lower portion 104c of the reservoir 104. An O-ring 103b is located at an insert within the lower lid 105. The lower lid 105 is screwed at the bottom of the bottom portion 104c of the reservoir 104 utilizing the O-ring 103b to create a vacuum seal in the reservoir 104. The lower lid 105 is shaped to complement the shape of the lower portion 104c. In the example, the body portion 104a, and lower portion 104c are shaped cylindrically so to complement the shape of the lower portion 104c, the lower lid 105 is shaped hemispherically with a set of threads 105a internally configured therein. In an embodiment, where the reservoir 104 is shaped in an angular manner (E.g. polygonal, cuboidal, etc.) then accordingly the lower lid 105 will be shaped for the working of the lower lid 105. The lower lid 105 is adapted to maintain a vacuum in the reservoir 104. Maintaining a vacuum inside reservoir 104 helps in a steady flow of water from the reservoir 104 to the soil in the pot.

Referring to FIGS. 1-4, the self-watering system 100 further includes a base unit 106 coupled to the lower lid 105. The base unit 106 is located centered in the middle of the lower portion 104c of reservoir 104. In an embodiment, the base unit 106 is an integral part of the lower lid 105. In another embodiment, the base unit 106 is screwed to the lower lid 105. The base unit 106 comprises a set of threads (not seen) that engages to a set of threads (not seen) present underside the lower lid 105.

Referring to FIGS. 1-4, the self-watering system 100 further includes a water transfer member 110. The water transfer member 110 is tube-like structure that's inserted in the base unit 106 and remains in fluid communication with the base unit 106. In one embodiment, the water transfer member 110 is screwed in the base unit 106. The water transfer member 110 according to the embodiment is a hollow straw of a predetermined length. In an embodiment, the water transfer member 110 is pointed at an end for ease of piercing into the soil to deliver water into the soil. The water transfer member 110 may be metallic, wooden or be made of any other sturdy material able to pierce through the soil for water delivery.

In an embodiment, the reservoir 104 is replaceable with reservoir 104 having a different volumetric capacity. However, it should be noted that the replaceable reservoir 104 would have an upper portion 104b and a lower portion 104c that would allow use of the existing upper lid 102 and the lower lid 105 without having to replace even the lids 102,105 along with the reservoir 104.

Referring to FIGS. 1-4, the self-watering system 100 further includes a ring assembly 107. The ring assembly 107 comprises a ring 107b and a plurality of legs 109 connected to the ring. The ring 107b includes a plurality of downwardly extending protrusions 107a configured for receiving the plurality of legs 109 inside. The ring assembly 107 with the plurality of legs 109 acts as a stand to support and provide stability to the self-watering system 100. In the example shown, there are three legs 109 shown connected to the ring 107b using the protrusions 107a forming a tripod stand, however, it should be understood that there can be a greater number of legs 109 connected to the corresponding protrusions 107a provided in the ring 107b of the ring assembly 107.

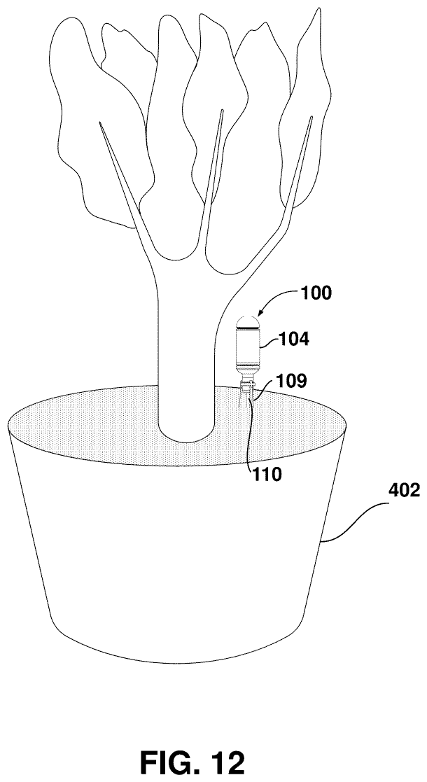

In operation, referring to FIGS. 1-4 in conjunction with FIG. 12, firstly, the upper lid 102 is opened and the reservoir 104 is filled with water. Secondly, the watering system 100 is then located or made to stand on the soil of the potted plant 402. The water transfer member 110 is inserted inside the soil. The legs 109 of the ring assembly 107 help support and provide stability to the watering system 100 when the watering system 100 is configured on the pot 402 to water the plant. Depending upon the plant pot size and the type of plant, the users, if need be, can replace the reservoir 104 with a different capacity reservoir 104. After a predetermined time, the user can perform a check to see if the reservoir 104 is emptied (due to flow of water into the soil of the potted plant 402). If the user determines, the reservoir 104 to be emptied, then the next step involves pouring water within the reservoir (104) through the upper lid (102) by selectively opening the lid 102. The watering system 100 is so designed that the user is not even required to dislocate the watering system 100 out of the plotted plant to refill the water thereinside.

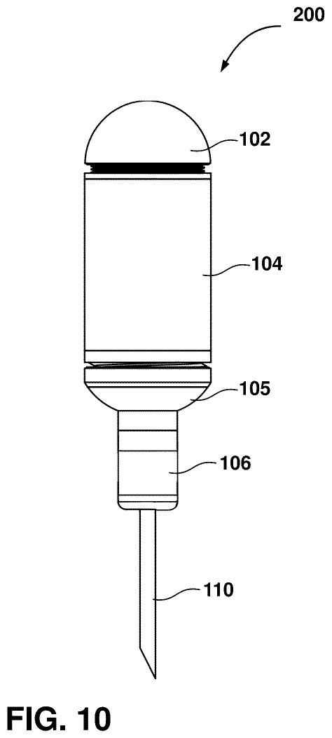

Although the preferred embodiment involves the use of the ring assembly 107, it is envisioned that the present invention can work without the ring assembly 107 as illustrated in an alternative embodiment of FIG. 10. Essentially, all the components forming the self-watering system 200 are identical to the components of FIG. 1 except the exclusion of the ring assembly 107.

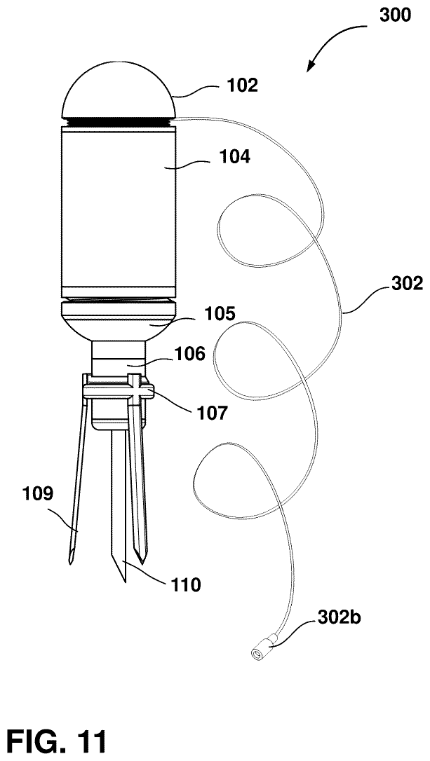

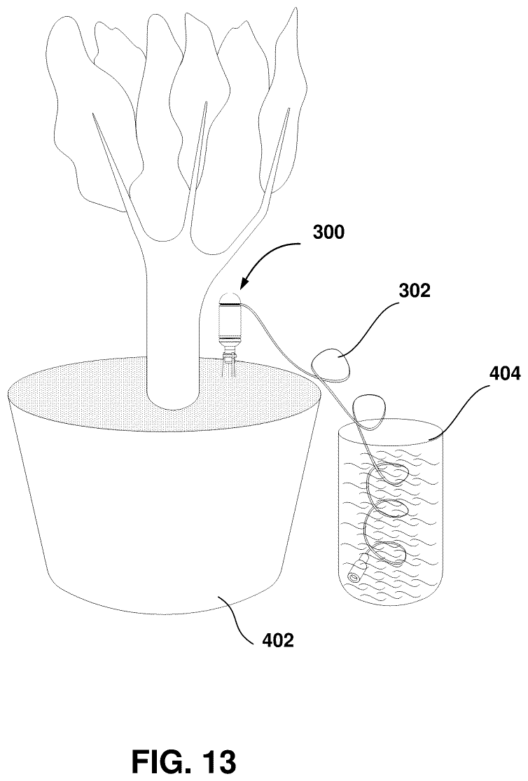

FIG. 11 shows an alternative embodiment of the self-watering system 100 according to an embodiment. In this embodiment, the self-watering system 300 is primarily the same as the embodiment shown in FIG. 1, however, the watering system 300 comprises a hose 302 provided with the upper lid 102. A first end 302a (not seen) of the hose 302 is connected to the upper lid 102 for auto-filling the reservoir 104 and a second end 302b of the hose 302 is disposed or located within a vessel 404 containing water. FIG. 13 shows a use case scenario utilizing the watering system 300 of FIG. 11, in operation, this embodiment is operated the same as the embodiment shown in FIG. 12 except that reservoir 104, in this case, is filled utilizing a hose 302 that transfers water from water containing vessel 402 to the reservoir 104. When the reservoir 104 has water, the same is steadily delivered into the soil. This version of the watering system 300 uses automated water drawing from a water vessel 404 when the reservoir 104 containing water gets emptied instead of necessitating the user to open the lid 102 to fill up the reservoir 104. The watering system 100 delivers water through the straw 110 into the soil when the plant needs it. The vacuum formation in the reservoir 104 due to use of O rings 103a, 103b, and lids 102,105 ensures there is no loss of water from reservoir 104 via evaporation, thus emptying the reservoir 104.

The various components, and parts of the various embodiments of the self-watering system (100, 200, 300) of the present invention are similar and interchangeable. It is obvious to the one skilled in the art that the various components and parts of the self-watering system (100, 200, 300) of the present invention could be considered for other embodiments with little or no variation.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. A self-watering system (100) for a potted plant (402), comprising:
a reservoir (104) having a body portion (104a), an upper portion (104b), and a lower portion (104c), wherein the reservoir (104) is fillable with water;
an upper lid (102) that engages with the upper portion (104b) of the reservoir (104);
a lower lid (105) that engages with the lower portion (104c) of the reservoir (104);
a base unit (106) coupled to the lower lid (105) and centered in the middle of the lower portion (104c); and
a water transfer member (110) coupled to the base unit (106) and in fluid communication with the reservoir (104), wherein the water transfer member (110) is adapted for delivering water into the soil of the potted plant (402).

2. The self-watering system (100) of claim 1, wherein the reservoir (104) is hollow cylindrical in shape.

3. The self-watering system (100) of claim 1, wherein the diameter of the lower portion (104c) and the upper portion (104b) of the reservoir (104) is reduced in comparison to the diameter of the body portion (104) thereof.

4. The self-watering system (100) of claim 1, wherein the diameter of the lower portion (104c) and the upper portion (104b) of the reservoir (104) are identical to the diameter of the body portion (104) thereof.

5. The self-watering system (100) of claim 1, wherein the diameter of the lower portion (104c) and the upper portion (104b) of the reservoir (104) are similar or different.

6. The self-watering system (100) of claim 1, wherein the water transfer member (110) is a hollow straw of a predetermined length.

7. The self-watering system (100) of claim 6, wherein the water transfer member (110) is pointed at an end for ease of piercing into the soil to deliver the water thereinside.

8. The self-watering system (100) of claim 1, wherein the upper lid (102) is screwed on top of the upper portion (104b) of the reservoir (104) such that a first set of internal threading (102a) of the upper lid (102) engages with a first set of external threading (104d) located on the upper portion (104b).

9. The self-watering system (100) of claim 8, wherein the upper lid (102) is screwed on top of the upper portion (104b) of the reservoir (104) utilizing a first O-ring (103a) located at an insert within the upper lid (102) to create a vacuum seal.

10. The self-watering system (100) of claim 1, wherein the lower lid (105) is screwed at the bottom of the bottom portion (104c) of the reservoir (104) such that a second set of internal threading (105a) of the lower lid (105) engages with a second set of external threading (104e) located on the lower portion (104c).

11. The self-watering system (100) of claim 10, wherein the lower lid (105) is screwed at the bottom of the bottom portion (104c) of the reservoir (104) utilizing a second O-ring (103b) located at an insert provided within the lower lid (105) to create a vacuum seal.

12. The self-watering system (100) of claim 1 further comprising a ring assembly (107) having a plurality of legs (109) connected thereto.

13. The self-watering system (100) of claim 1, wherein the ring assembly (107) with the plurality of legs (109) acts as a stand to support and provide stability to the self-watering system (100).

14. The self-watering system (100) of claim 1, wherein the upper lid (102) is adapted to maintain a vacuum in the reservoir (104) and allow for the pouring of water in the reservoir (104) while the self-watering system (100) is grounded on the potted plant (402).

15. The self-watering system (100) of claim 1, wherein the base unit (106) is screwed to the lower lid (105) and the water transfer member (110) is screwed to the base unit (106).

16. The self-watering system (100) of claim 1, wherein the reservoir (104) is replaceable with a reservoir (104) having a different volume but having identical upper portion (104b) and lower portion (104c) such as to allow uses of an upper lid (102) and the lower lid (105).

17. The self-watering system (100) of claim 1, wherein the upper lid (102) further comprising a hose (302) with a first end of the hose (302) connected thereto for auto-filling the reservoir (104) and a second end of the hose (302) located within a vessel (404) containing water.

18. A self-watering system (100) for a potted plant (402), comprising:
a reservoir (104) of a hollow cylindrical shape, the reservoir (104) including a body portion (104a), an upper portion (104b), and a lower portion (104c);
an upper lid (102), and a lower lid (105) that engages with the upper portion (104b), and the lower portion (104c) of the reservoir (104) respectively creating a vacuum in the reservoir (104);
a base unit (106) coupled to the lower lid (105);
a water transfer member (110) coupled to the base unit (106) and in fluid communication with the reservoir (104), the water transfer member (110) serves to transfer the water to the soil and root of a plant in the pot (402); and
a ring assembly (107) having a plurality of legs (109) connected thereto, wherein the ring assembly (107) with the plurality of legs (109) is adapted to support and provide stability to the self-watering system (100) when the self-watering system (100) is made to stand on the soil of the plant pot (402) for watering the plant.

19. The self-watering system (100) of claim 18, wherein the ring assembly (107) comprising a plurality of downwardly extending protrusions (107a) configured for receiving the plurality of legs (109) thereinside.

20. The self-watering system (100) of claim 18, wherein the upper lid (102) is screwed on top of the upper portion (104b) of the reservoir (104) utilizing a first O-ring (103a) such that a first set of internal threading (102a) of the upper lid (102) engages with a first set of external threading (104d) located on the upper portion (104b).

21. The self-watering system (100) of claim 18, wherein the lower lid (105) is screwed at the bottom of the bottom portion (104c) of the reservoir (104) utilizing a second O-ring (103b) such that a second set of internal threading (105a) of the lower lid (105) engages with a second set of external threading (104e) located on the lower portion (104c).

22. A method of watering a potted plant (402) comprising the steps of:
(a) locating a self-watering system (100) adjacent a plant to be watered, the self-watering system (100) comprising
a reservoir (104) fillable with water, wherein the reservoir (104) including an upper portion (104b), and a lower portion (104c), wherein the reservoir (104) is fillable with water;
an upper lid (102), and a lower lid (105) that engages with the upper portion (104b), and the lower portion (104c) of the reservoir (104) respectively creating a vacuum in the reservoir (104);
a base unit (106) coupled to the lower lid (105); and
a water transfer member (110) coupled to the base unit (106) and in fluid communication with the reservoir (104) for delivering water into the soil of the potted plant (402); and
(b) pouring water within the reservoir (104) through the upper lid (102) when the reservoir is determined to be emptying, wherein the upper lid (102) is selectively opened to fill the water inside the reservoir (104).

23. The method of watering plants of claim 22, wherein the step of locating the self-watering system (100) adjacent to the plant of the pot (402) further comprising steps of piercing a plurality of legs (109) connected to a ring assembly (107) into the soil of the pot (402), and ensuring the water transfer member (110) is well inserted within the soil for water delivery.
